(19) United States
(12) Patent Application Publication
(10) Pub. No.: US 2026/0044317 A1
(43) Pub. Date: Feb. 12, 2026

(54) AUTOMATED APPLICATION DEVELOPMENT IN A TELECOMMUNICATIONS SYSTEM

(71) Applicant: T-Mobile USA, Inc., Bellevue, WA (US)

(72) Inventor: Phi Hoang Nguyen, Bellevue, WA (US)

(21) Appl. No.: 18/799,125

(22) Filed: Aug. 9, 2024

(51) Int. Cl. G06F 8/35; G06F 8/10

(52) U.S. Cl. CPC G06F 8/35; G06F 8/10

(57) ABSTRACT

Techniques for automating generation of an application using a generative machine learned model are described herein. A telecommunications system can implement an application generation system for receiving an inquiry and/or question associated with bringing an application to market including generating computer readable instructions using one or more generative machine learned models. The techniques can also or instead include determining a level of risk, an overall cost, and/or feasibility for generating the application. The application generation system can implement a large language model (LLM) that predicts outcomes for various stages of a software development life cycle to improve timing, overall quality, and reliability to develop the application.

### BACKGROUND

Modern terrestrial telecommunication systems include heterogeneous mixtures of second, third, and fourth generation (2G, 3G, and 4G) cellular-wireless access technologies, which can be cross-compatible and can operate collectively to provide data communication services. Global Systems for Mobile (GSM) is an example of 2G telecommunications technologies; Universal Mobile Telecommunications System (UMTS) is an example of 3G telecommunications technologies; and Long Term Evolution (LTE), including LTE Advanced, and Evolved High-Speed Packet Access (HSPA+) are examples of 4G telecommunications technologies. Telecommunications systems may include fifth generation (5G) cellular-wireless access technologies to provide improved bandwidth and decreased response times to a multitude of devices that may be connected to a network.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 depicts an example network environment in which an example computing device can connect to a telecommunications system that includes an example application generation system to implement the techniques described herein.

FIG. 2 depicts an example system architecture for a fifth generation (5G) telecommunication network.

FIG. 3 depicts another example network environment in which an example computing device can connect to a telecommunication system that includes an example application generation system to implement the techniques described herein.

FIG. 4 depicts a messaging flow for providing a response to a request to develop an application using an example application generation system.

FIG. 5A depicts a first part of a flowchart of an example process for predicting outcomes and a time to generate an application by an example application generation system.

FIG. 5B depicts a second part of a flowchart of an example process for predicting outcomes and a time to generate an application by an example application generation system.

FIG. 6 depicts an example system architecture for a computing device.

### DETAILED DESCRIPTION

This application relates to techniques for automating development of an application by a telecommunications operator. The techniques can include an application generation system receiving an inquiry and/or question associated with bringing an application to market including generating computer readable instructions using one or more generative machine learned models. For example, a developer can send the inquiry to a computing device that predicts a period of time, budget, computational resources, human resources, roadblocks, etc. associated with generating a reliable application for deployment to customers of the telecommunications operator. The techniques can, for example, be used to speed up a software development life cycle by applying machine learned techniques to rapidly generate and validate requirements, design optimal architectures, and quickly provide feedback to specific questions about an application. In various examples, the application generation system can predict potential issues to completing various stages of developing an application, service, computer-readable instructions, etc. and predict solutions to the potential issues based on historical data. By using the techniques described herein, an application can be generated in less time and with improved overall quality and reliability versus not implementing the application generation system, for example.

The techniques described herein can include a computing device (e.g., the application generation system) determining a level of risk, an overall cost, and feasibility for generating the application. For example, the computing device can implement a large language model (LLM) that predicts outcomes for various stages in developing an application. By implementing the computing device as described herein, computer readable instructions can be generated independent of requiring input from a human (e.g., a subject matter expert) in less time (e.g., from a year to several months). The LLM can, for example, be trained to improve predictions associated with a stage of application development over time (e.g., a planning stage, a requirement stage, a design stage, a develop stage, a test stage, a deployment stage, and/or a maintenance stage). By automatically generating an application as described herein, fewer messages can be sent over a core network of the telecommunications system thereby improving network capacity, efficiency, etc.

The application generation system can, for example, receive one or more questions from a component of a client computing device (or user thereof) and provide answers to the one or more questions for display on a display device of the client computing device. To answer a question or inquiry, the application generation system can aggregate data from multiple data sources and analyze the aggregated data to draw conclusions about the risk level, likelihood for success, required resources, etc. For example, a component of a computing device associated with a developer of an application can inquire about a budget, a length of time, available resources, etc. and the application generation system can transmit at least some of output data from the LLM to the component of the client computing device.

In some examples, the application generation system can access, receive, or otherwise determine input data for a machine learned model from one or more data sources. In some examples, the application generation system can receive data representing available computational resources, available services (e.g., or the telecommunications system and/or a third-party device), current products offered by the telecommunications system, objectives of the telecommunications system, research associated with subject matter of the application (e.g., current market conditions, etc.), available application program interfaces, just to name a few.

The application development techniques described herein can, for example, generate computer-readable instructions usable to define and/or satisfy requirements of a particular stage of a set of stages usable for generating an application. For instance, the application generation system can create, modify, or otherwise determine code to integrate an available service, resource, etc. into the application (e.g., instead of relying on a developer or other user). In this way, the application generation system can reduce or eliminate requiring input from a human to generate the application. In some examples, the application generation system can output a risk value representing a level of risk for generating the first application (e.g., low, medium, high, or the like).

In some examples, the application generation system can generate standardized procedures over time that are usable to complete a stage of application development. For example, standards for a stage of application development can be determined based at least in part on previous applications developed by the application generation system. Accordingly, processes, procedures, or the like can be used to generate consistent practices for generating at least a portion of a current application in less time and with more accuracy versus not implementing the application generation system.

In various examples, the application generation system may represent firmware, hardware and/or software that performs techniques to generate computer readable instructions for a new application and/or for an existing application. The techniques described herein can improve a computing device and/or network in a variety of ways. Quality of service, network bandwidth, can be improved by predicting outcomes of various stages of application development free of requiring that messages be exchanged over a core network. For instance, messages from a developer and/or between computing devices of various entities responsible for developing different portions of the application can be prevented from reaching the core network thereby improving bandwidth of the core network. By exchanging fewer messages to develop an application, additional bandwidth is available on the core network (e.g., for exchanging data with user equipment). Further, using the techniques described herein can improve transmission of message data from a UE using a telecommunications network by reducing latency otherwise caused by messages being exchanged.

The techniques may also improve the telecommunications system use of available network entities (e.g., base station, network elements, etc.), processor resources, memory resources, and the like. For example, the application generation system can implement a machine learned model (e.g., an LLM) to assign available computational resources, available memory resources, etc. to efficiently generate the application using the fewest computational resources, memory resources, etc.

Although at least some of the descriptions provided herein may be in the context of telecommunication systems, the proposed concepts, schemes, and any variations thereof may be implemented in, for and by systems of other service providers, such as cloud service providers that include software as a service (SaaS) providers, content as a service (CaaS) providers, data as a service (DaaS) providers, etc.

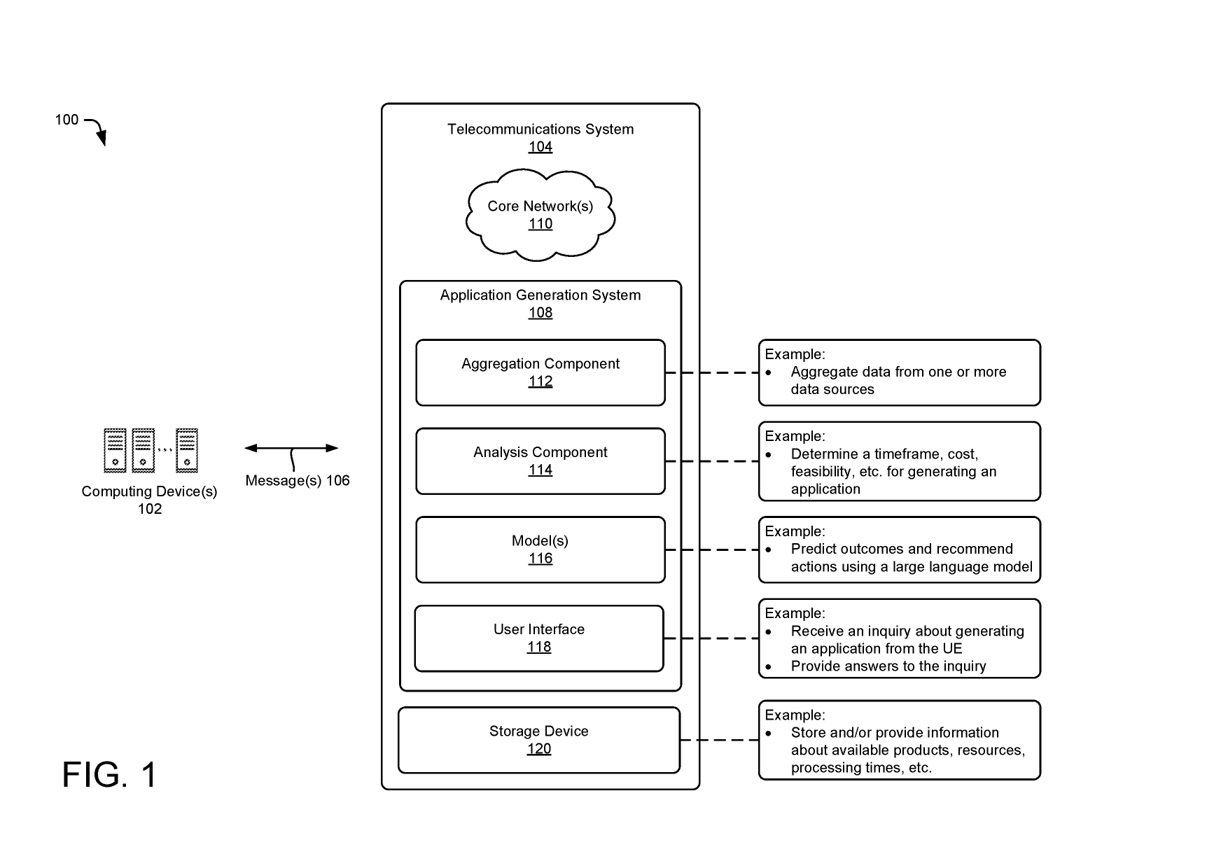

FIG. 1 depicts an example network environment 100 in which an example computing device can connect to a telecommunications system that includes an example application generation system to implement the techniques described herein. For example, one or more computing devices 102 (may also be referred to as the computing device 102 or the computing devices 102) can initiate access a telecommunications system 104 by sending a message 106 to an application generation system 108 configured to determine data usable for generating an application. In various examples, the computing device(s) 102 can receive application data from the application generation system 108 via one or more core networks 110 (may also be referred to as the core network 110 or the core network(s) 110).

The computing device 102 may represent any device that can wirelessly connect to the telecommunication network, and in some examples may include a mobile phone such as a smart phone or other cellular phone, a personal digital assistant (PDA), a personal computer (PC) such as a laptop, desktop, or workstation, a media player, a tablet, a gaming device, a smart watch, a hotspot, a Machine to Machine device (M2M), a vehicle (e.g., an autonomous vehicle, an unmanned aerial vehicle, airplane, boat, etc.), an Internet of Things (IoT) device, or any other type of computing or communication device.

The message 106 from the computing device 102 can, for example, indicate a request for information associated with generating an application at a first time. In some examples, the message 106 can represent a response (e.g., a budget, timeframe, requirements, etc.) from the application generation system 108 to the computing device 102 at a second time different from the first time. The core network 110 can represent a 5G network in various examples, though other core network types may also be used (e.g., past or future generation networks such as a sixth generation (6G) network).

The application generation system 108 may represent firmware, hardware and/or software that generates, assigns, selects, or otherwise automatically determines application data for an application. For example, the application generation system 108 can predict a time, an outcome, a requirement, and/or a confidence level, etc. for completing a stage of developing an application, such as a stage of a software development life cycle (SDLC). In some examples, the application generation system 108 can identify a service (e.g., provided by the telecommunications system and/or a third-party), a computational resource (e.g., a processing resource, memory resource, network resource, etc.), and/or an architecture (e.g., a combination of components that collectively operate to provide functionality for the application). By implementing the application generation system 108, an amount of time to complete generating an application (or portion thereof) can be reduced.

In various examples, the computing device 102 can send a message 106 comprising one or more questions related to generating at least a portion of the application. Based on receiving the message 106 (e.g., a first message), the application generation system 108 can transmit responses (e.g., a second message) to the one or more questions over the core network 110 to the computing device 102.

FIG. 1 depicts the application generation system 108 comprising an aggregation component 112, an analysis component 114, one or more models 116, and a user interface 118. FIG. 1 further depicts the telecommunications system 104 (e.g., a 5G system) comprising the application generation system 108, the core network(s) 110, and a storage device 120. The application generation system 108 (or component thereof) may, for example, exchange data with the storage device 120 (e.g., a memory, a database, etc.) to implement the application generation techniques described herein.

The aggregation component 112 can, for example, represent functionality to sample, receive, collect, or otherwise determine data for processing by the application generation system 108 (or component thereof). In some examples, the aggregation component 112 can aggregate data from one or more data sources such as from a database or storage device storing information related to a product, an application service, a resource, objectives of the telecommunications system 104, and/or an application program interface, etc. The aggregation component 112 can also or instead access, receive, or gather data from a database storing information associated with a user such as the subject matter expert of the telecommunications system 104, previous results associated with generating an application at a previous time. In some examples, aggregated data can be stored in the storage device 120 and updated over time. In some examples, the storage device 120 can provide information to the computing device 102 usable to recommend a service, product, or network entity for the computing device 102 to access (e.g., recommend a service based on previous services, products, etc.).

The analysis component 114 can represent functionality to determine a timeframe, a cost, feasibility, one or more challenges to overcome, a deficiency in available human resources, etc. for generating an application. For example, the analysis component 114 can receive aggregated data from the aggregation component 112 and determine a timeframe, cost, etc. for one or more stages of development required to generate the application. In various examples, the analysis component 114 can analyze input data from the one or more data sources using one or more of the models 116.

The analysis component 114 can, in some examples, determine data for presentation by a display device of the computing device 102 (e.g., present data determined by the analysis component 114, the models 116, etc.). The presentation data can be included in a message 106 transmitted by the analysis component 114 over the core network(s) 110, for instance.

The one or more models 116 may be representative of machine learned models, non-machine learning models, or a combination thereof. That is, a model may refer to a machine learning model that learns from a training data set to improve accuracy of an output (e.g., a prediction). Additionally or alternatively, a model may represent logic and/or mathematical functions that generate approximations which are usable to make predictions (e.g., a heuristic model, a statistical model, etc.).

In some examples, the model(s) 116 can represent a large language model (LLM) configured to predict an outcome for one or more stages of developing an application. For instance, the LLM can predict a timeframe, a cost, a likelihood of success, or the like based at least in part on processing the aggregated data as input. The LLM can, for example, identify a deficiency of available computational resources, human resources, or the like impacting generation of the application. In various examples, the LLM can recommend one or more actions to remedy the identified deficiencies to improve an amount of time to generate the application. In some examples, the LLM can identify a network entity, an application program interface, or other data required to generate the application in the least amount of time. The network entity can represent, for example, a base station, an antenna, a transceiver, a serving node, or a computing device of the core network 110, just to name a few.

In various examples, a machine learned model may be trained based at least in part on training data. Training data may include a wide variety of data, such as previously generated application data, image data, video data, audio data, network activity data, etc., that is associated with a value (e.g., a desired classification, inference, prediction, etc.). Such values may generally be referred to as a “ground truth.” To illustrate, the training data may be used for determining data usable for generating the application and, as such, may include data associated with historical application generation. In some examples, training data may be based on user input (e.g., user input indicating that the certain data is required to generate the application) and/or may be based on the output of another machine learned model. In some examples, such labeled data (or more generally, the labeled output associated with training data) may be referred to as ground truth.

The user interface 118 can represent functionality to exchange (e.g., send and/or receive) associated with the computing device 102. For example, an instance of the user interface 118 can be provided to the computing device 102 to receive an inquiry, question, etc. from the computing device 102 and optionally present a response to the inquiry, question, and so on

The storage device 120 can provide functionality to store and/or provide data associated with an application, service, API, etc. usable for providing the techniques described herein. For example, the storage device 120 can receive historical data associated with the computing device 102, application data associated with one or more previously generated applications, research data associated with an application for generation, data representing human knowledge such as that of an acute subject matter expert, among others.

Generally, the storage device 120 can provide functionality including storing application information, network information, computing device information (e.g., capacity, required resources, etc.), user information, and the like. In some examples, the storage device 120 can store, determine, and/or provide information associated with the computing device 102 for use by a component. For instance, the aggregation component 112 can receive information indicating historical activity by the computing device 102 over a previous time period for determining a response for the computing device 102.

The storage device 120 can provide functionality to store and/or provide data associated with a network element or the computing device 102 usable for providing the techniques described herein. For example, the storage device 120 can receive network information from various network elements.

The storage device 120 can represent, for example, a Unified Data Management (UDM) to manage user data and/or an Authentication Server Function (AUSF) to manage authorization for the computing device 102 (e.g., in the 5G system shown). However, in examples when the core network is a different type, such as 4G, the storage device 120 can represent a Home Subscriber Server (HSS). Thus, the storage device 120 can represent various subscription management entities depending upon the example core network used to employ the techniques.

In various examples, output data from a component of the application generation system 108 can be stored in the storage device 120 for access at a later time. For example, the storage device 120 can receive activity associated with an application, a core network, or the like, for storage and make such data available to a component for processing at a later time.

To implement the techniques described herein, in various examples the telecommunications system 104 and/or the application generation system 108 can include one or more of: an a proxy call session control function (P-CSCF), an interrogating call session control function (ICSCF), a serving call session control function (SCSCF), a serving gateway (SGW), a packet data network gateway (PGW), a policy and charging rules function (PCRF), and an internet protocol short message gateway (IPSM-GW), a short message service center (SMSC), and an evolved packet data gateway (ePDG), and a Home Subscriber Server (HSS), just to name a few. In addition, the techniques described herein may be implemented using Real-Time Protocol (RTP) and/or Real-Time Control Protocol (RTCP), among others.

In various examples, the telecommunications system 104 (e.g., a 5G system) can represent functionality to provide a communication channel for the computing device 102 and can include one or more radio access networks (RANs), as well as one or more core networks linked to the RANs. For instance, the computing device 102 can represent a UE to wirelessly connect to a base station or other access point of a RAN, and in turn be connected to the core network (e.g., a 5G core network). The RANs and/or core networks can be compatible with one or more radio access technologies, wireless access technologies, protocols, and/or standards. For example, wireless and radio access technologies can include fifth generation (5G) technology, Long Term Evolution (LTE)/LTE Advanced technology, other fourth generation (4G) technology, third generation (3G) technology, High-Speed Data Packet Access (HSDPA)/Evolved High-Speed Packet Access (HSPA+) technology, Universal Mobile Telecommunications System (UMTS) technology, Global System for Mobile Communications (GSM) technology, WiFi technology, and/or any other previous or future generation of radio access technology. In this way, the telecommunications system 104 is compatible to operate with other radio technologies including those of other service providers. Accordingly, the message(s) 106 from the computing device 102 may originate with another service provider (e.g., a third-party) and be processed by the application generation system 108 independent of the technolog(ies) or core network associated with the service provider.

While shown separately in FIG. 1, the aggregation component 112, the analysis component 114, and the model(s) 116 (and the functionality thereof) can be included in a single component of the telecommunications system 104 and/or in another computing device associated with the telecommunications system 104. Further, the functionality associated with the application generation system 108 can be included as hardware coupled to the computing device 102.

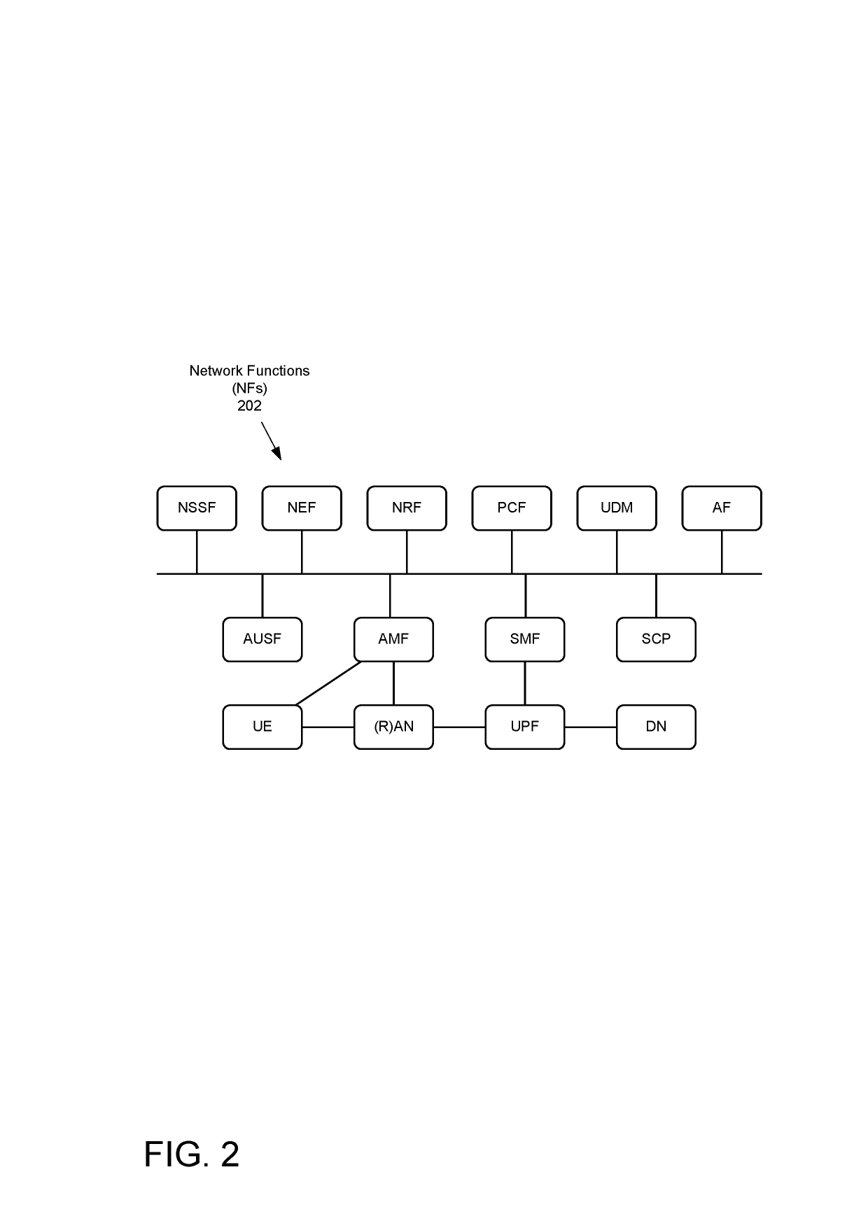

In some examples, the core network 110 can represent a service-based architecture that includes multiple types of network functions that process control plane data and/or user plane data to implement services for the computing device 102. In some examples, the services comprise rich communication services (RCS), a VoNR service, a ViNR service, and the like which may include a text, a data file transfer, an image, a video, or a combination thereof. The network functions of the core network 110 can include an Access and Mobility Management Function (AMF), a Session Management Function (SMF), a User Plane Function (UPF), a Policy Control Function (PCF), and/or other network functions implemented in software and/or hardware, just to name a few. Examples of network functions are also discussed in relation to FIG. 2, and elsewhere.

FIG. 2 depicts an example system architecture for a fifth generation (5G) telecommunication network. In some examples, the 5G telecommunication network can comprise the core network 110 in FIG. 1 that includes a service-based system architecture in which different types of network functions (NFs) 202 operate alone and/or together to implement services. Standards for 5G communications define many types of NFs 202 that can be present in 5G telecommunication networks (e.g., the 5G core network), including but not limited to an Authentication Server Function (AUSF), Access and Mobility Management Function (AMF), Data Network (DN), Unstructured Data Storage Function (UDSF), Network Exposure Function (NEF), Network Repository Function (NRF), Network Slice Selection Function (NSSF), Policy Control Function (PCF), Session Management Function (SMF), Unified Data Management (UDM), Unified Data Repository (UDR), User Plane Function (UPF), Application Function (AF), User Equipment (UE), (Radio) Access Network ((R)AN), 5G-Equipment Identity Register (5G-EIR), Network Data Analytics Function (NWDAF), Charging Function (CHF), Service Communication Proxy (SCP), Security Edge Protection Proxy (SEPP), Non-3GPP InterWorking Function (N3IWF), Trusted Non-3GPP Gateway Function (TNGF), and Wireline Access Gateway Function (W-AGF), many of which are shown in the example system architecture of FIG. 2.

One or more of the NFs 202 of the core network 110 can be implemented as network applications that execute within containers (not shown). The NFs 202 can execute as hardware elements, software elements, and/or combinations of the two within telecommunication network(s), and accordingly many types of the NFs 202 can be implemented as software and/or as virtualized functions that execute on cloud servers or other computing devices. Network applications that can execute within containers can also include any other type of network function, application, entity, module, element, or node.

The core network 110 can, in some examples, determine a connection between an IMS that manages a communication session for the computing device 102, including sessions for short messaging, voice calls, video calls, and/or other types of communications. For example, the computing device 102 and the IMS of the telecommunications system 104 can exchange Session Initiation Protocol (SIP) messages to set up and manage individual communication sessions.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

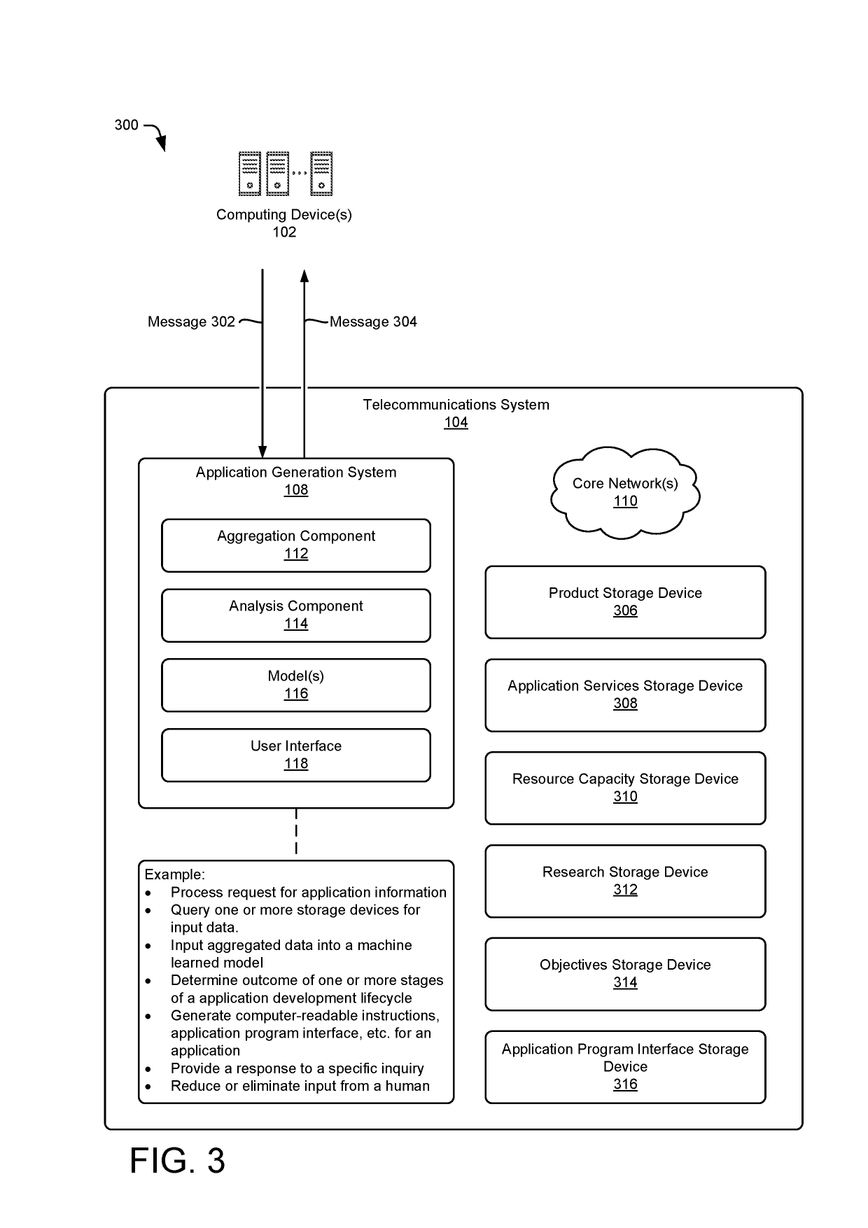

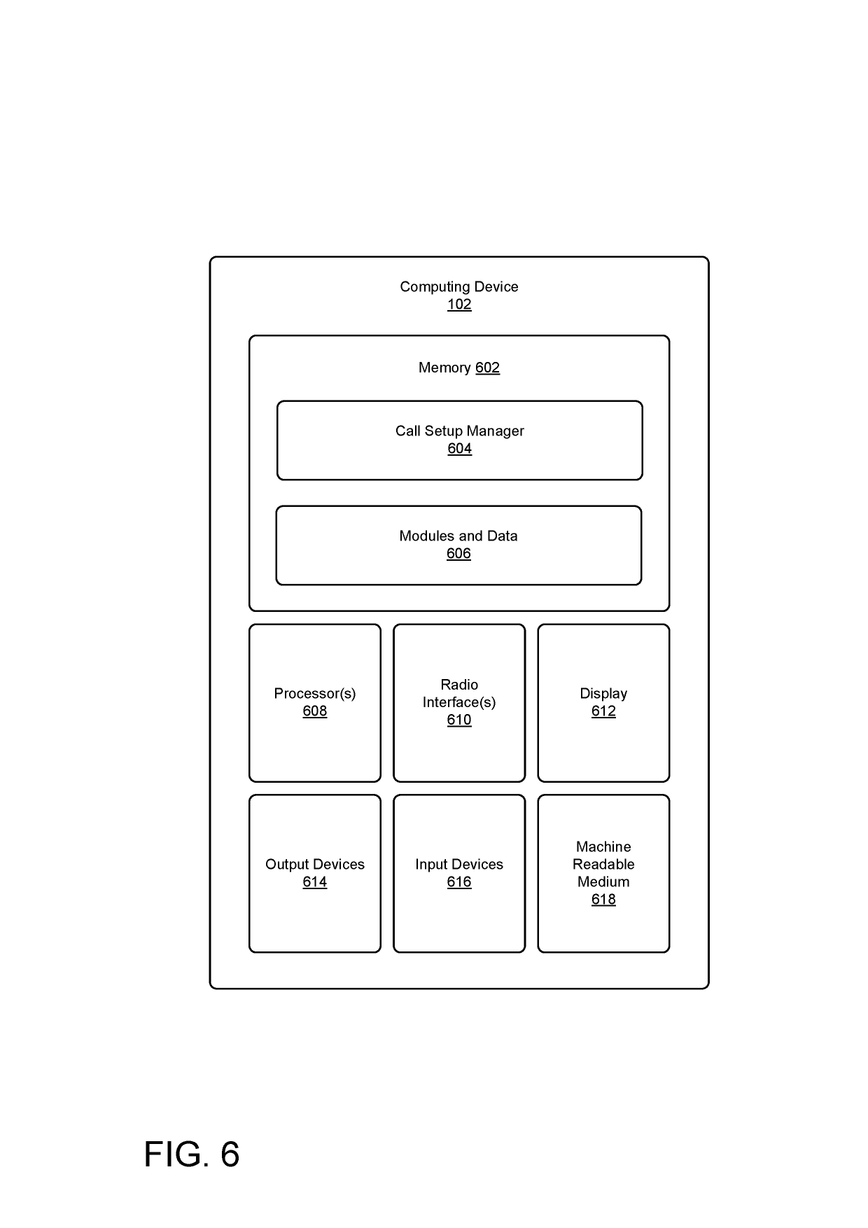

FIG. 3 depicts another example network environment 300 in which an example computing device can connect to a telecommunication system that includes an example application generation system to implement the techniques described herein. For example, the computing device(s) 102 can send a message 302 to the application generation system 108 of FIG. 1 requesting information related to generating or maintaining an application. The application generation system 108 can determine one or more responses for sending to the computing device(s) 102 over the core network(s) 110 as a message 304. An example architecture for the computing device(s) 102 is illustrated in greater detail in FIG. 6.

FIG. 3 further depicts the telecommunications system 104 comprising a product storage device 306, an application services storage device 308, a resource capacity storage device 310, a research storage device 312, an objective storage device 314, and an application program interface storage device 316. Though depicted as separate storage devices in FIG. 3, data stored in the product storage device 306, the application services storage device 308, the resource capacity storage device 310, the research storage device 312, the objective storage device 314, and the application program interface storage device 316 may, in some examples, be includes in a single storage device, such as the storage device 120 of FIG. 1. In various examples, the aggregation component 112 can receive data from one or more of the respective storage devices to implement automated application techniques described herein.

The application generation system 108 can, for example, process a request for application information from the computing device(s) 102 and initiate a query of one or more storage devices for input data. The input data may be processed by a machine learned model, such as an LLM, to determine an outcome of one or more stages of an application development life cycle.

In some examples, the application generation system 108 can generate computer readable instructions, an application program interface, or other data usable for an application. For example, the models 116 can represent an LLM that is configured to generate the computer readable instructions instead of requiring input from a developer or other user. In this way, the application generation system 108 can provide a response to specific inquiries from the computing devices 102 without relying on input from a human. By using the techniques described herein, the application generation system 108 can generate the application using fewer computational resources, human resources, etc. typically required using an application development life cycle.

The product storage device 306 can include data associated with a current product and/or a desired product of the telecommunications system 104. For instance, the product storage device 306 can include product artifacts and documentation, a resource repository identifying required resources for a product, a product implementation cost repository, a product roadmap, and/or a product backlog, etc.

The application services storage device 308 can include data associated with existing applications, an environment associated with the applications, as well as staging information for an objective for the application. For example, the application services storage device 308 can indicate product artifacts and documentation related to different stages of development such as an alpha stage, a beta stage, a golden stage, etc.

The resource capacity storage device 310 can include available resources previously used to generate an existing application and/or resources available to generate a new application. Available resources may represent, for example, computational resources, human resources, or the like. The resource capacity storage device 310 can also or instead identify a service usable to generate the application. For example, the resource capacity storage device 310 can represent a third-party service such as a cloud service from a third-party usable to deploy the application. In some examples, the combination of available services can be identified for providing computational resources (e.g., a network resource, processor resource, memory resource, human resource, etc.) to generate and/or maintain the application.

The research storage device 312 can include research information associated with generating new applications. For example, the research storage device 312 can store data associated with a machine learned model, a desired application, research documents, and/or techniques for developing previously generated applications. In some examples, the research storage device 312 can represent a knowledge database usable to predict requirements for developing the application. The knowledge database can represent human knowledge and//or information about current technologies available or usable for developing an application.

The objective storage device 314 may include objective data such as security, legal, and/or other compliance requirements associated with generating an application by the telecommunications system 104. For example, the objective storage device 314 can identify goals of the telecommunications system 104 including the security, the legal, and/or the compliance requirements required of a new application. By accessing data from the objective storage device 314, the application generation system 108 can ensure that an application aligns with financial, security, and other objectives of the telecommunications system 104.

The application program interface storage device 316 can include application program interfaces (APIs) associated with a component, service, or computing device usable to generate the application. For instance, previously used APIs and/or newly available APIs can be organized into a common database for access by a component.

In various examples, the application generation system 108 can generate requirements for the generation of the application, validate the requirements, and generate output data based at least in part on validating the requirements. The output data can, for example, be transmitted as the message 304 to the computing device(s) 102. In some examples, the analysis component 114 can output a risk value representing a level of risk for generating the application. The risk value can, for example, be based at least in part on data aggregated from one or more of the respective storage devices (e.g., objectives, available resources, predicted outcomes, etc.). In some examples, the risk value can include a classification such as a high level of risk, medium level of risk, low level of risk, though other classifications or levels of risk may also or instead be used.

In some examples, the application generation system 108 can identify an API associated with a service by accessing data associated with the API storage device and determine whether to implement and/or modify the API for generation of the application. For instance, based at least in part on data associated with a previously generated application, the application generation system 108 can determine whether or not to use an existing API, modify an existing API, or generate a new API to enable generation of the application.

As mentioned, the application generation system 108 can predict an outcome representing an obstacle to generate the application (e.g., based at least in part on analysis of historical data). For instance, historical data associated with a previous question from the computing devices 102 (or other computing device), another application, and/or data associated with the telecommunications network can be accessed for processing by the application generation system 108. In various examples, the application generation system 108 can generate a solution for the identified obstacle to improve reliability of the application after deployment.

In various examples, the application generation system 108 can predict a time to generate the application including a period of time to complete one or more of the various stages of application development. For example, stages of application development can include concept initiation, planning, requirements gathering, design, development, testing, deployment, and/or maintenance stages. The concept initiation stage can include defining a core idea, analyzing feasibility studies, performing cost-benefit analysis, and/or aligning an application project with objectives of the telecommunications system. The planning stage may include, for example, defining the project scope, timeline, resources, and risk management. The requirements gathering stage can include identifying functional and non-functional requirements to define clear, comprehensive, and validated requirements of the project. The design stage may include, for example, determining a system architecture (e.g., high-level and/or low-level designs) such as a user interface, system interface, and database design. The development stage can include determining computer-readable instructions (e.g., coding) representing design documents provided by a developer or computing device. The testing stage can, for example, include performing one or more tests to ensure that an interface, computer-readable instructions, etc. are usable and accepted by an end user. The deployment stage can include installation, configuration, and/or data migration in a production environment and may further include determining training and documentation for the project. The maintenance stage may include, for example, analyzing the functionality of the application over time to identify and mitigate an update to the application, performance enhancements, and/or adapting to new requirements after the initial requirements. In this way, delays and/or inconsistencies among applications developed using a development life cycle can be mitigated thereby producing an application in less time and more consistently versus not implementing the application generation system 108.

The application generation system 108 can access the resource capacity storage device 310 to receive information representing human knowledge to circumvent human input otherwise required to develop the application. For example, a model 116 can gather data from subject matter experts associated with one or more stages of application development and store the data in the resource capacity storage device 310 to reduce or eliminate delays associated with receiving data from a human.

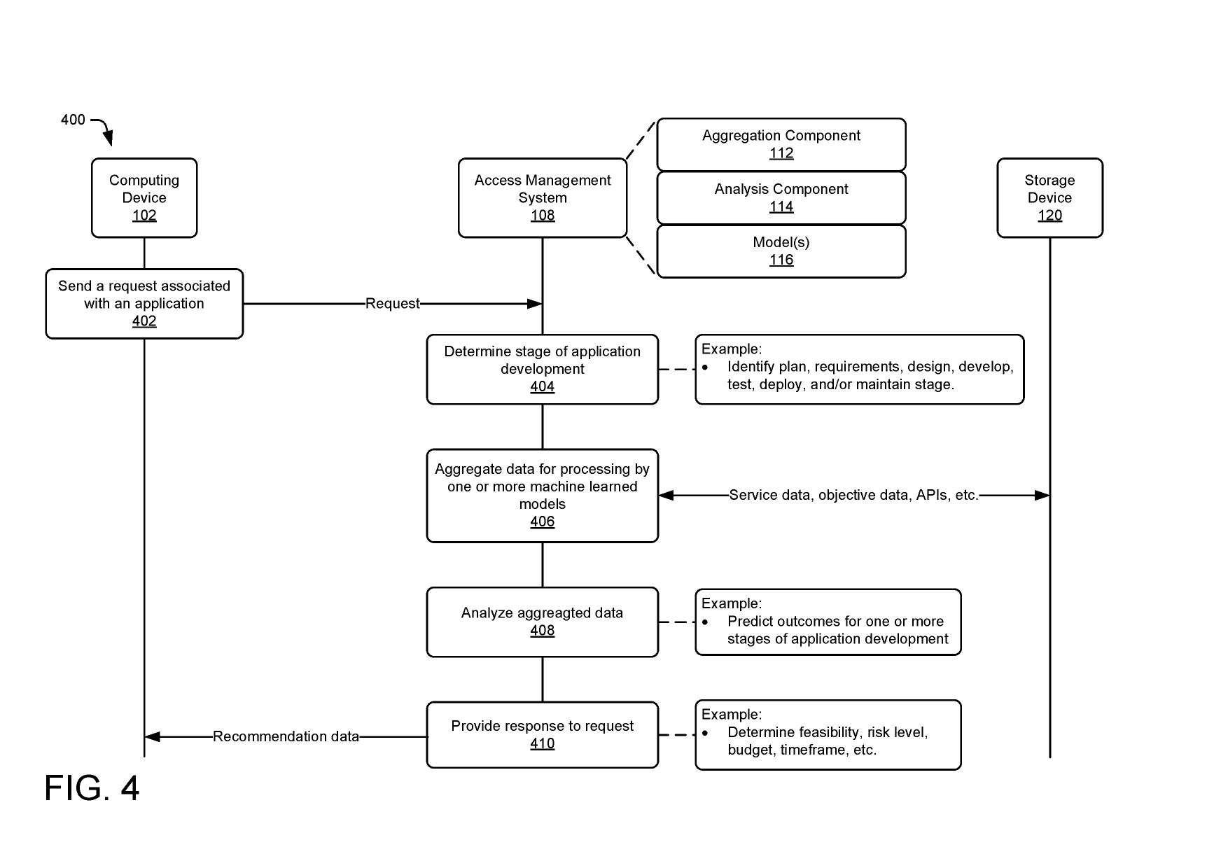

FIG. 4 depicts a messaging flow 400 for providing a response to a request to develop an application using an example application generation system. For example, the computing device 102 of FIG. 1 may exchange (e.g., send and/or receive) one or more messages with the application generation system 108 (e.g., the aggregation component 112, the analysis component 114, and/or the model(s) 116) to generate, modify, or otherwise determine application data associated with an application. In some examples, functionality associated with the aggregation component 112, the analysis component 114, and/or the model(s) 116 can be included in a computing device, or other entity of the telecommunications system 104. In some examples, the application generation system 108 can, for example, determine one or more responses to an inquiry, question, or the like received from the computing device(s) 102 as describe herein.

In various examples, the computing device 102 may be associated with a developer of the application. For example, the computing device 102 can inquire about developing an application by sending a request to the application generation system 108 that is configured to determine obstacles, requirements, etc. for developing an application associated with the computing device 102.

At 402, the computing device(s) 102 can send a request associated with an application over the core network(s) 110 to the application generation system 108 of the telecommunications system 104. In various examples, the computing device 102 may be associated with a developer of the application and the computing device 102 can request application information such as a likelihood for the application to be developed, a timeline for generating the application, and/or a solution for an obstacle to generating the application, just to name a few. The application generation system 108 can be employed to provide a response to various questions such as whether a particular feature has been implemented in an environment, whether it is possible to implement a new application, a level of effort to generate the application (e.g., low, medium, high), teams impacted to have a feature generated, a cost to generate the application, available resources to implement the feature, and/or a time to generate the feature of the application.

At 404, the application generation system 108 can determine a stage of application development. For example, the analysis component 114 can identify whether the stage is associated with a plan stage, requirement stage, design stage, development stage, test stage, deployment stage, and/or maintenance stage. In various examples, the stages can be associated with a software development life cycle (SDLC). The analysis component 114 can implement a machine learned model to analyze the request and determine which stage(s) is relevant to the request. In some examples, the analysis component 114 can parse the request to identify whether the request is associated with a particular stage of the SDLC.

At 406, the application generation system 108 can aggregate data for processing by one or more machine learned models. For example, the aggregation component 112 can access data stored in a storage device (e.g. the storage device 120) based at least in part on determining the stage of application development. The application generation system 108 can, for example, identify service data (e.g., data associated with a service usable for generating the feature), objective data (e.g., an object of the telecommunications system 104), API data associated with one or more APIs, etc. based on the determined stage.

At 408, the application generation system 108 can analyze the aggregated data. By way of example and not limitation, the analysis component 114 receive the aggregated data from the aggregation component 112 and predict an outcome(s) for one or more stages of application development. The outcome may be associated with feasibility, a risk level, a budget, a period of time, etc. for generating the application.

At 410, the application generation system 108 can provide a response to the request from the computing device(s) 102. For instance, the analysis component 114 can provide recommendation data as a response to the request. In some examples, the analysis component 114 may employ a machine learned model (e.g. the model 116) to predict a time to generate the application, a service to generate the application, a computational resource to generate the application, and/or an architecture for generating the application. In some examples, the machine learned model can represent an LLM that predicts a first outcome of a first stage of a set of stages that impacts the generation of the application, a second outcome of a second stage of the set of stages that impacts the generation of the application, and/or a confidence level associated with the generation of the first application. The confidence level can represent a level of confidence for the application generation system 108 to generate the application based on the predicted outcomes.

Though the aggregation component 112, the analysis component 114, and/or the model(s) 116) are illustrated in FIG. 4 individually, it is understood that the aggregation component 112, the analysis component 114, and/or the model(s) 116 (or functionality provided therefrom) may be directly coupled to and/or integrated into a single component or computing device (including in some examples the computing device(s) 102).

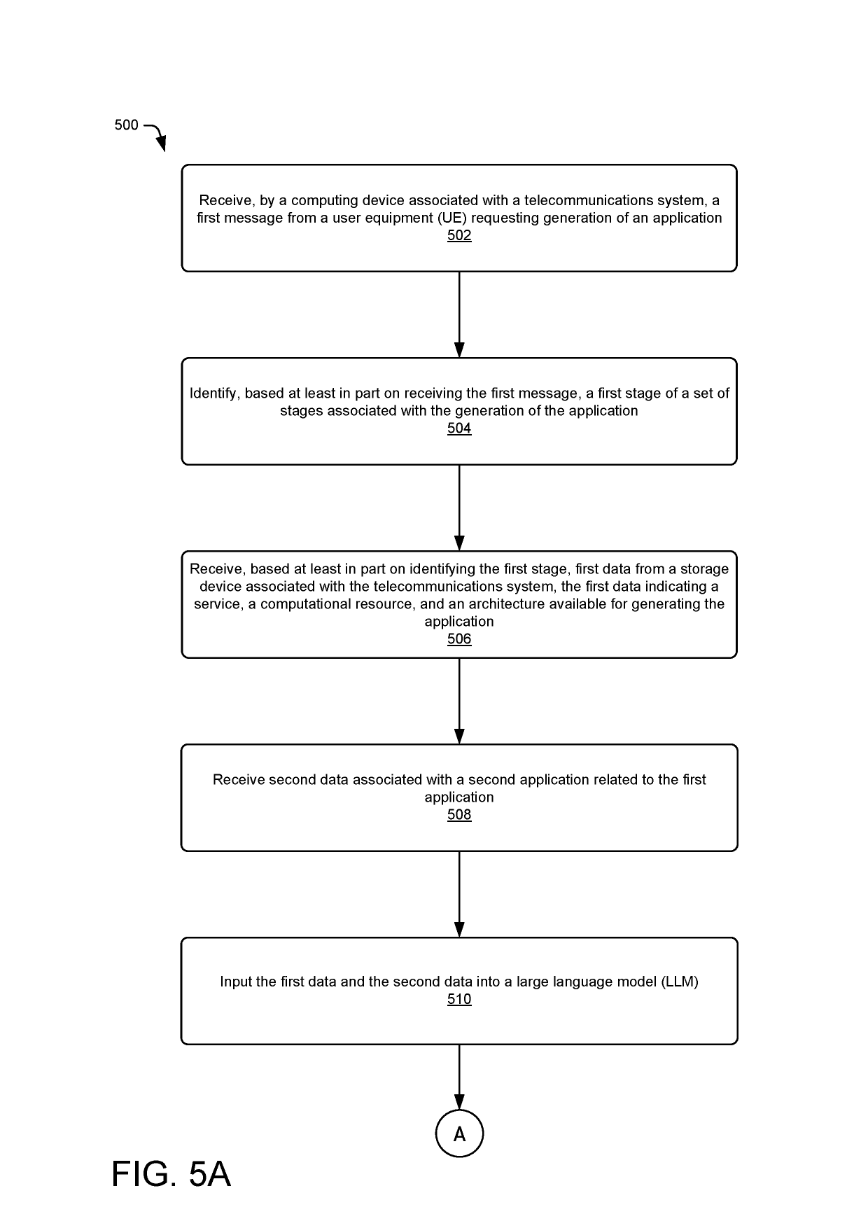

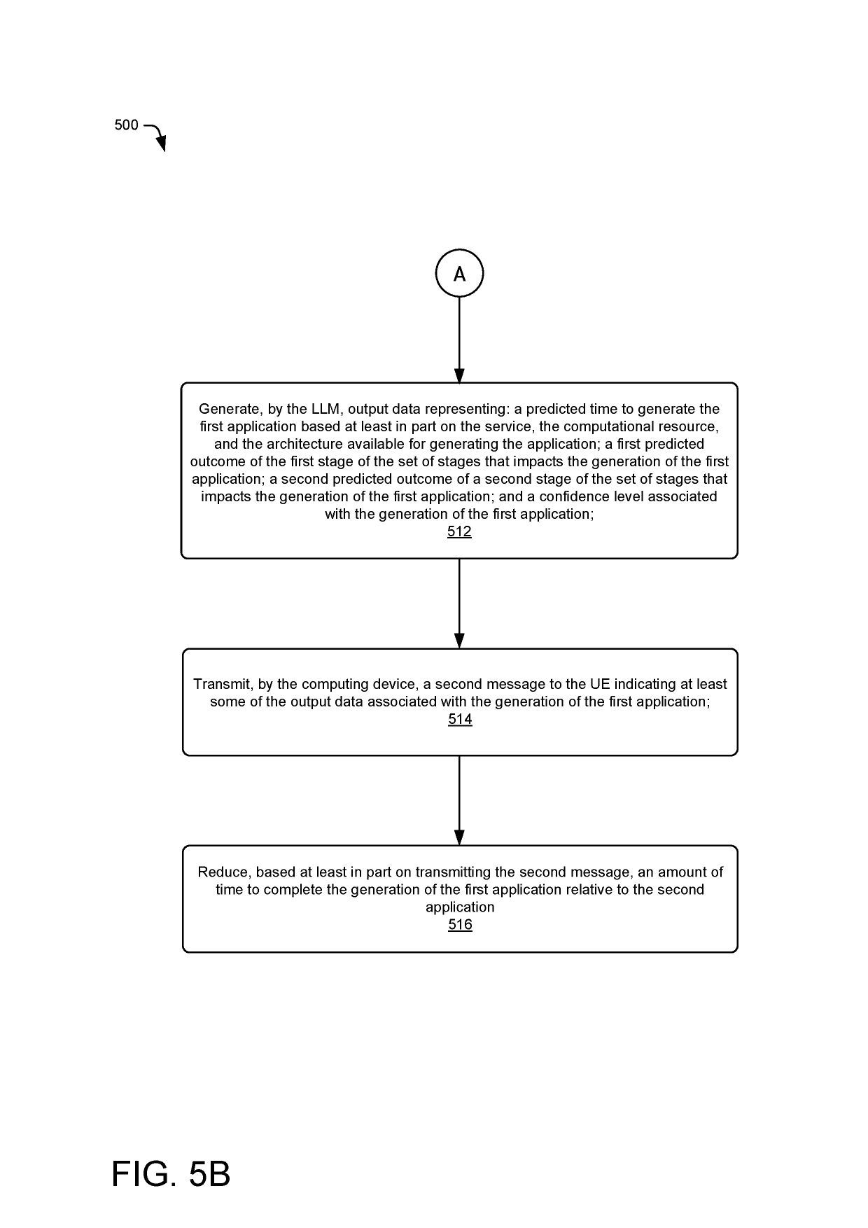

FIG. 5A depicts a first part of a flowchart of an example process 500 for predicting outcomes and a time to generate an application by an example application generation system. Some or all of the process 500 may be performed by one or more components in FIGS. 1-4, as described herein. For example, some or all of process 500 may be performed by the application generation system 108 of FIG. 1.

At operation 502, the process may include receiving, by a computing device associated with a telecommunications system, a first message from a user equipment (UE) requesting generation of a first application. For example, a computing device of the telecommunications system 104 can receive the message 302 from the computing device(s) 102 indicating a request to generate an application. The computing device can represent the application generation system 108 and may include one or more of: the aggregation component 112, the analysis component 114, or the model(s) 116.

At operation 504, the process may include identifying, based at least in part on receiving the first message, a first stage of a set of stages associated with the generation of the first application. For example, the analysis component 114 can identify a particular stage of a set of stages for developing an application, such as the software development life cycle. In various examples, a question or inquiry can be parsed to determine one or more stages related to the question or inquiry.

In some examples, data received as input (e.g., as part of the first message or data associated therewith) can be analyzed by the analysis component 114 to determine whether a stage of the set of stages has completed (e.g., a first status or classification) or not completed (e.g., a second status or classification). For instance, each stage of the set of stages can include various criteria, requirements, sub-stages, etc. to be considered complete. In examples when at least some criteria, requirement, sub-stage, etc. is missing or incomplete, the respective stage can be identified as incomplete, and consequently associated with a question, inquiry, or the like. By way of example and not limitation, a concept stage can be associated with one or more user personas, user stories, wireframes, etc. and a design stage can be associated with a high-level architecture drawing, a low-level architecture drawing, connections, and/or relationships between applications or components, just to name a few. In some examples, an implementation/development stage can be associated with applications and/or component that accept particular input data and generate corresponding responses that correctly and accurately respond to the input data. In various examples, a deployment stage (e.g., production readiness, etc.) can be associated with one or more accessible applications that can be identified and used to complete the respective stage. Thus, each stage of the set of stages can be associated with specific data that, if identified in the first message, can enable the analysis component 114 to determine that the first message relates to a particular stage.

At operation 506, the process may include receiving, based at least in part on identifying the first stage, first data from a storage device associated with the telecommunications system, the first data indicating a service, a computational resource, an objective, and an architecture available for generating the first application. In some examples, the operation 506 may include the application generation system 108 accessing data from one or more storage devices (e.g., the product storage device 306, the application services storage device 308, the resource capacity storage device 310, the research storage device 312, the objective storage device 314, and the application program interface storage device 316).

At operation 508, the process may include receiving second data associated with a second application related to the first application. In some examples, the operation 508 may include the application generation system 108 accessing data associated with the second application generated by the computing device at a previous time. For example, the application generation system 108 can determine whether another application (e.g. a second application generated at a previous time) includes a process, resource, etc. associated with a current application for development.

In some examples, the operation 508 can include determining whether an application, component, and/or application service is related to another application, component, and/or application service based at least in part on the analysis component 114 comparing required data for the applications, components, and/or application services (e.g., data required for completion). For example, data representing requirements for various applications, components, and/or application services can be compared one to another to identify similar or closely aligned requirements between two or more applications, components, and/or application services. In various examples, the analysis component 114 can determine whether to create a new application (or use an existing application) based at least in part on evaluating content in previous requests, questions, inquiries, etc. with content in a current request, question, inquiry, etc. In some examples, the analysis component 114 can represent a large language model that identifies and/or categorizes the requirements of various stages (e.g., within an accuracy threshold) to ensure that each stage of the set of stages are associated with the correct data. By way of example and not limitation, the large language model can, at a concept initiation stage (and/or other stage), determine requirements for the concept initiation stage and optionally other stages thereby ensuring that subsequent comparison of requirements produces accurate relationships between various applications. At operation 510, the process may include inputting the first data and the second data into a large language model (LLM). For example, the data aggregated by the aggregation component 112 can be input into one or more of the models 116.

FIG. 5B depicts a second part of a flowchart of an example process 500 for predicting outcomes and a time to generate an application by an example application generation system.

At operation 512, the process may include generating, by the LLM, output data representing: a predicted time to generate the first application based at least in part on the service, the computational resource, and the architecture available for generating the first application; a first predicted outcome of the first stage of the set of stages that impacts the generation of the first application; a second predicted outcome of a second stage of the set of stages that impacts the generation of the first application; and a confidence level associated with the generation of the first application. For example, the application generation system 108 can implement the analysis component 114, the one or more models 116, etc. to predict an obstacle, a requirement, a timeframe, or the like based at least in part on associations between the different types of aggregated data.

At operation 514, the process may include transmitting, by the computing device, a second message to the UE indicating at least some of the output data associated with the generation of the first application. For example, the application generation system 108 can send the message 304 to the computing device 102 indicating at least some of the data out by the LLM. In some examples, the second message can include responses to a request in the message 302 from the computing device 102.

At operation 516, the process may include reducing, based at least in part on transmitting the second message, an amount of time to complete the generation of the first application relative to the second application. In some examples, the application generation system 108 can reduce an amount of time to development one or more stages of the set of stages associated with the application. In various examples, the operation 516 can be performed independent of requiring operation 514 (e.g., without transmitting data to the computing device 102). The LLM can, for example, generate output data usable for developing the application for storage in one or more storage devices.

FIG. 6 depicts an example system architecture for one of the computing device(s) 102, in accordance with various examples. As shown, the computing device 102 can have memory 602 storing a call setup manager 604, and other modules and data 606. The computing device 102 can also comprise processor(s) 608, radio interfaces 610, a display 612, output devices 614, input devices 616, and/or a machine readable medium 618.

In various examples, the memory 602 can include system memory, which may be volatile (such as RAM), non-volatile (such as ROM, flash memory, etc.) or some combination of the two. The memory 602 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing device 102. Any such non-transitory computer-readable media may be part of the computing device 102.

The call setup manager 604 can send and/or receive messages comprising a VoNR service, a ViNR service, and/or an RCS service including SIP messages associated with setup and management of a call session via an IMS, an AMF, or the like. The SIP messages can include an SIP INVITE message and/or other SIP messages.

The other modules and data 606 can be utilized by the computing device 102 to perform or enable performing any action taken by the computing device 102. The modules and data 606 can include a UE platform, operating system, and applications, and data utilized by the platform, operating system, and applications.

In various examples, the processor(s) 608 can be a central processing unit (CPU), a graphics processing unit (GPU), or both CPU and GPU, or any other type of processing unit. Each of the one or more processor(s) 608 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 608 may also be responsible for executing all computer applications stored in the memory 602, which can be associated with common types of volatile (RAM) and/or nonvolatile (ROM) memory.

The radio interfaces 610 can include transceivers, modems, interfaces, antennas, and/or other components that perform or assist in exchanging radio frequency (RF) communications with base stations of the telecommunication network, a Wi-Fi access point, and/or otherwise implement connections with one or more networks. For example, the radio interfaces 610 can be compatible with multiple radio access technologies, such as 5G radio access technologies and 4G/LTE radio access technologies. Accordingly, the radio interfaces 610 can allow the computing device 102 to connect to a 5G system and/or a 4G system (or other past or future system) as described herein.

The display 612 can be a liquid crystal display or any other type of display commonly used in UEs. For example, display 612 may be a touch-sensitive display screen, and can then also act as an input device or keypad, such as for providing a soft-key keyboard, navigation buttons, or any other type of interactive input. In some examples, the display 612 can represent a wearable device such as a headset for presenting and/or receiving data associated with a user. The output devices 614 can include any sort of output devices known in the art, such as the display 612, speakers, a vibrating mechanism, and/or a tactile feedback mechanism. Output devices 614 can also include ports for one or more peripheral devices, such as headphones, peripheral speakers, and/or a peripheral display. The input devices 616 can include any sort of input devices known in the art. For example, input devices 616 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 618 can store one or more sets of instructions, such as software or firmware, that embodies any one or more of the methodologies or functions described herein. The instructions can also reside, completely or at least partially, within the memory 602, processor(s) 608, and/or radio interface(s) 610 during execution thereof by the computing device 102. The memory 602 and the processor(s) 608 also can constitute machine readable media 618.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

### CONCLUSION

Although the subject matter has been described in language specific to structural features and/or methodological acts, it is to be understood that the subject matter is not necessarily limited to the specific features or acts described above. Rather, the specific features and acts described above are disclosed as example embodiments.

While one or more examples of the techniques described herein have been described, various alterations, additions, permutations and equivalents thereof are included within the scope of the techniques described herein. For instance, techniques described in FIGS. 5 and 6 can be combined in various ways.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method comprising:
receiving, by a computing device associated with a telecommunications system, a first message from a user equipment (UE) requesting generation of a first application;
identifying, based at least in part on receiving the first message, a first stage of a set of stages associated with the generation of the first application;
receiving, based at least in part on identifying the first stage, first data from a storage device associated with the telecommunications system, the first data indicating a service, a computational resource, and an architecture available for generating the first application;
receiving second data associated with a second application related to the first application, the second application generated by the computing device at a previous time;
inputting the first data and the second data into a large language model (LLM);
generating, by the LLM, output data representing:
a predicted time to generate the first application based at least in part on the service, the computational resource, and the architecture available for generating the first application;
a first predicted outcome of the first stage of the set of stages that impacts the generation of the first application;
a second predicted outcome of a second stage of the set of stages that impacts the generation of the first application; and
a confidence level associated with the generation of the first application;
transmitting, by the computing device, a second message to the UE indicating at least some of the output data associated with the generation of the first application; and
reducing, based at least in part on transmitting the second message, an amount of time to complete the generation of the first application relative to the second application.

2. The method of claim 1, further comprising:
generating requirements for the generation of the first application; validating the requirements; and generating the output data based at least in part on validating the requirements.

3. The method of claim 1, further comprising:
outputting, by the LLM, a risk value representing a level of risk for generating the first application.

4. The method of claim 1, further comprising:
receiving third data representing an objective of a telecommunications operator; inputting the third data in the LLM; and generating the output data to align the generation of the first application with the objective of the telecommunications operator.

5. The method of claim 1, further comprising:
identifying an application program interface (API) associated with the service or the computational resource; and determining whether to modify the API for the generation of the first application.

6. The method of claim 1, wherein:
the first data indicates one or more questions associated with the generation of the first application, and the output data comprises one or more responses to the one or more questions.

7. The method of claim 1, wherein:
the first predicted outcome represents an obstacle to generate the first application based at least in part on analysis of historical data, and the method further comprising:
generating a solution for the obstacle to improve reliability of the first application.

8. The method of claim 1, wherein generating the predicted time to generate the first application comprises:
determining a first period of time to complete the first stage; and determining a second period of time to complete the second stage.

9. A system comprising:
one or more processors; and
memory storing computer-executable instructions that, when executed by the one or more processors, cause the system to perform operations comprising:
receiving, by a computing device associated with a telecommunications system, a first message from a user equipment (UE) requesting generation of a first application;
identifying, based at least in part on receiving the first message, a first stage of a set of stages associated with the generation of the first application; receiving, based at least in part on identifying the first stage, first data from a storage device associated with the telecommunications system, the first data indicating a service, a computational resource, and an architecture available for generating the first application;
receiving second data associated with a second application related to the first application, the second application generated by the computing device at a previous time;
inputting the first data and the second data into a large language model (LLM);
generating, by the LLM, output data representing:
a predicted time to generate the first application based at least in part on the service, the computational resource, and the architecture available for generating the first application;
a first predicted outcome of the first stage of the set of stages that impacts the generation of the first application;
a second predicted outcome of a second stage of the set of stages that impacts the generation of the first application; and
a confidence level associated with the generation of the first application;
transmitting, by the computing device, a second message to the UE indicating at least some of the output data associated with the generation of the first application; and
reducing, based at least in part on transmitting the second message, an amount of time to complete the generation of the first application relative to the second application.

10. The system of claim 9, the operations further comprising:
generating requirements for the generation of the first application; validating the requirements; and generating the output data based at least in part on validating the requirements.

11. The system of claim 9, the operations further comprising:
outputting, by the LLM, a risk value representing a level of risk for generating the first application.

12. The system of claim 9, the operations further comprising:
receiving third data representing an objective of a telecommunications operator; inputting the third data in the LLM; and generating the output data to align the generation of the first application with the objective of the telecommunications operator.

13. The system of claim 9, wherein the storage device is a first storage device and the operations further comprising:
receiving, from a second storage device different from the first storage device, third data represent knowledge associated with a human resource of a telecommunications operator; and minimizing a requirement for the human resource to generate the first application based at least in part on receiving the third data.

14. The system of claim 9, wherein:
the computing device is configured to generate the first application using a Software Development Life Cycle (SDLC), and
the set of stages represent respective stages of the SDLC.

15. The system of claim 9, the operations further comprising:
generating computer readable instructions to represent the architecture.

16. The system of claim 9, the operations further comprising:
determining a first cost associated with the service, a second cost associated with the computational resource, and a third cost associated with the architecture; and
generating third data representing a budget for the generation of the first application based at least in part on the first cost, the second cost, and the third cost.

17. One or more non-transitory computer-readable media storing instructions executable by one or more processors, wherein the instructions, when executed, cause the one or more processors to perform operations comprising:
receiving, by a computing device associated with a service provider system, a first message from a user equipment (UE) requesting generation of a first application;
identifying, based at least in part on receiving the first message, a first stage of a set of stages associated with the generation of the first application;
receiving, based at least in part on identifying the first stage, first data from a storage device associated with the service provider system, the first data indicating a service, a computational resource, and an architecture available for generating the first application;
receiving second data associated with a second application related to the first application, the second application generated by the computing device at a previous time; inputting the first data and the second data into a large language model (LLM);
generating, by the LLM, output data representing:
a predicted time to generate the first application based at least in part on the service, the computational resource, and the architecture available for generating the first application;
a first predicted outcome of the first stage of the set of stages that impacts the generation of the first application;
a second predicted outcome of a second stage of the set of stages that impacts the generation of the first application; and
a confidence level associated with the generation of the first application;
transmitting, by the computing device, a second message to the UE indicating at least some of the output data associated with the generation of the first application; and
reducing, based at least in part on transmitting the second message, an amount of time to complete the generation of the first application relative to the second application.

18. The one or more non-transitory computer-readable media of claim 17, the operations further comprising:
generating requirements for the generation of the first application; validating the requirements; and generating the output data based at least in part on validating the requirements.

19. The one or more non-transitory computer-readable media of claim 17, the operations further comprising:
outputting, by the LLM, a risk value representing a level of risk for generating the first application.

20. The one or more non-transitory computer-readable media of claim 17, the operations further comprising:
receiving third data representing an objective of a telecommunications operator or service provider;
inputting the third data in the LLM; and
generating the output data to align the generation of the first application with the objective of the telecommunications operator or the service provider.
